(19) United States
(12) Patent Application Publication
(10) Pub. No.: US 2010/0241522 A1
(43) Pub. Date: Sep. 23, 2010

(54) CHECKOUT TERMINAL APPARATUS

(75) Inventor: Takeshi Tashiro, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/712,231

(22) Filed: Feb. 25, 2010

(30) Foreign Application Priority Data
Mar. 17, 2009 (JP) 2009-065019

(51) Int. Cl. G06Q 30/00; G06K 7/10

(52) U.S. Cl. 705/23; 705/16; 235/383

(57) ABSTRACT

A checkout terminal apparatus includes an apparatus body, an operation unit provided in the apparatus body and adapted for inputting transaction information of an article, and a cover member which is removably attached to the apparatus body according to need and covers at least the operation unit.

### CROSS-REFERENCE TO RELATED APPLICATION

This application is based upon and claims the benefit of priority from the prior Japanese Patent Application No. 2009-065019 filed Mar. 17, 2009, the entire contents of which are incorporated herein by reference.

### TECHNICAL FIELD

An embodiment of the present invention relates to checkout terminal apparatus such as a POS (point of sales) terminal apparatuses used for sales of articles.

### BACKGROUND

In stores like convenience stores, plural (for example, five or so) POS terminal apparatuses are usually arranged in order to be able to cope with many customers rushing for the checkout counter.

However, in order to operate all the POS terminal apparatuses, salesclerks need to be placed at all the POS terminals apparatuses. If those salesclerks cannot be placed, it is not possible to cope with crowding.

Thus, arranging a separate POS terminal apparatus for self-checkout so that customers can use the POS terminal apparatus themselves and thus coping with crowding is proposed, for example, in JP-A-7-121756.

However, if a separate POS terminal apparatus for self-checkout is especially provided, there is a problem that its arrangement space is required and the cost is increased accordingly.

### SUMMARY

In view of the above circumstances, an object of an aspect of the invention is to provide an inexpensive checkout terminal apparatus that can easily be used also as a self-checkout terminal apparatus.

A checkout terminal apparatus according to an aspect of the invention includes: an apparatus body; an operation unit provided in the apparatus body and adapted for inputting transaction information of an article; a control unit which executes article sale processing based on the transaction information inputted by the operation unit; and a cover member which is removably attached to the apparatus body according to need and covers at least the operation unit.

According to an aspect of the invention, the apparatus can easily be used also as a terminal apparatus for self-checkout and the cost can be reduced.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing the appearance of a POS terminal apparatus as an embodiment of the invention;

FIG. 2 is a block diagram showing a control circuit of the POS terminal apparatus of FIG. 1;

FIG. 3 is a perspective view showing a cover member used in the case of changing the POS terminal apparatus of FIG. 1 to a terminal for self-checkout;

FIG. 4 shows a state where the cover member of FIG. 3 is attached to the POS terminal apparatus of FIG. 1; and

FIG. 5 shows a state where a fixed scanner is attached to the cover member of FIG. 4.

### DETAILED DESCRIPTION

Hereinafter, an embodiment of the invention will be described with reference to the drawings.

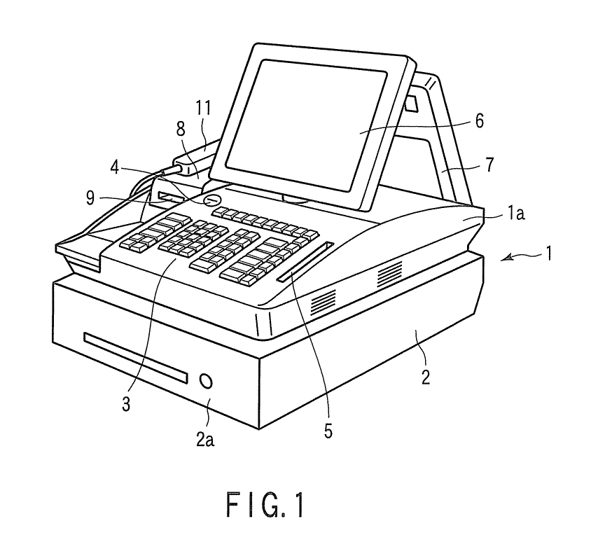

FIG. 1 shows the appearance of a checkout terminal apparatus according to an embodiment of the invention, for example, a POS (point of sales) terminal apparatus 1.

The POS terminal apparatus 1 has an apparatus body 1a. Below the apparatus body 1a, there is a drawer unit 2 as a drawer section having a drawer 2a for housing cash and so on. The POS terminal apparatus 1 is installed, for example, on the checkout counter in a store.

On the front side of the apparatus body 1a of the POS terminal apparatus 1, a keyboard 3 as an operation unit, a mode switch 4, a card reader 5 and a clerk-side display device (color liquid crystal display device) 6 are provided. On the rear side, a customer-side display device (color liquid crystal display device) 7 is removably provided.

Also, in the apparatus body 1a of the POS terminal apparatus 1, an electronic journal 8 which saves journals in an electronic medium, a printer 9 which prints receipts and journals and so on are provided.

Moreover, a scanner, for example, a hand scanner 11 is led out as an article information input unit from the apparatus body 1a of the POS terminal apparatus 1. This hand scanner 11 optically scans information attached to an article, that is, a barcode printed on an article label or the like.

The keyboard 3 has numeric keys to numerically input a deposit amount and the like, a subtotal key to designate the total output of an article or articles registered for sale in one transaction, a deposit or current total key to indicate to declare cash settlement of the price of one transaction and thus designate the summing of the transaction, a clear key to designate the clearance of the numeric data, and so on.

The mode switch 4 is a switch to select various operation modes including “registration”, “inspection”, “payment”, “setting” and the like and is operated by a dedicated key.

In the card reader 5, a card used for non-cash settlement is inserted and slid. Thus, the card reader 5 reads data recorded on the card.

The clerk-side display device 6 displays the name and price of an article that is registered for sale by an article registration unit, the total amount, the deposit amount and the amount of change in one transaction that are provided by a registration summing unit as the end of the article sale registration is declared, and so on.

The customer-side display device 7 displays advertisement information using a color photograph or a color dynamic image, customer guide information such as a message “Welcome”, transaction details (the article name, the unit price, and the number of article units), transaction results (the total amount, the deposit amount, and the amount of change) and the like.

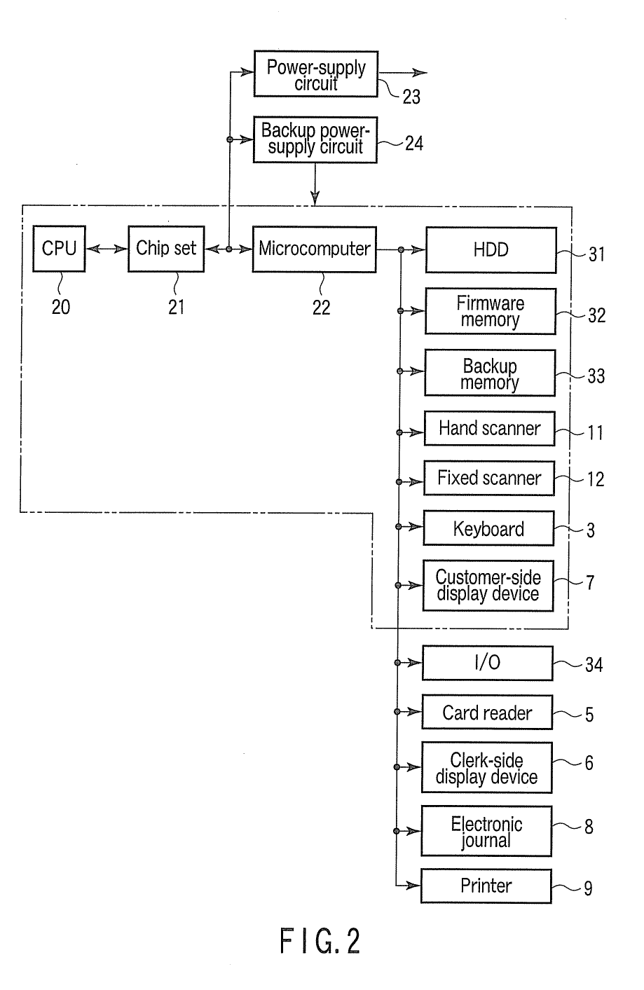

FIG. 2 shows a control circuit of the above-described POS terminal apparatus 1.

A microcomputer 22 which executes various kinds of processing with respect to the sale of articles, a power-supply circuit 23 which outputs an operating voltage of the POS terminal apparatus 1, and a backup power-supply circuit 24 which outputs a backup operating voltage at the time of suspension are connected to a CPU (central processing unit) 20 and a chip set 21. A hard disk drive (HDD) 31, a firmware memory 32, a backup memory 33, the hand scanner 11, a fixed scanner 12, the keyboard 3, the customer-side display device 7, an I-O (input-output) port 34, the card reader 5, the clerk-side display device 6, the electronic journal 8 and the printer 9 are connected to the microcomputer 22.

The microcomputer 22 has, its main function, a control unit which sequentially executes article sale processing in accordance with scanned information from the hand scanner 11 and the fixed scanner 12, which will be described later, and the operation of the keyboard 3.

In the above configuration, when a customer takes an article or articles to the checkout counter, a salesclerk faces the customer at the checkout counter where the POS terminal apparatus 1 is installed. The salesclerk then sequentially scans barcodes on all the articles taken thereto by the customer, with the hand scanner 11, and carries out a predetermined operation for registration and payment on the keyboard 3. The scanned information from the hand scanner 11 at this time is taken into the microcomputer 22. The microcomputer 22 executes a series of processing including registration and payment with respect to the customer's articles in accordance with the scanned information that is taken in and the keyboard operation by the salesclerk. Information that needs to be displayed in the execution of this processing is properly displayed on the clerk-side display device 6 and the customer-side display device 7.

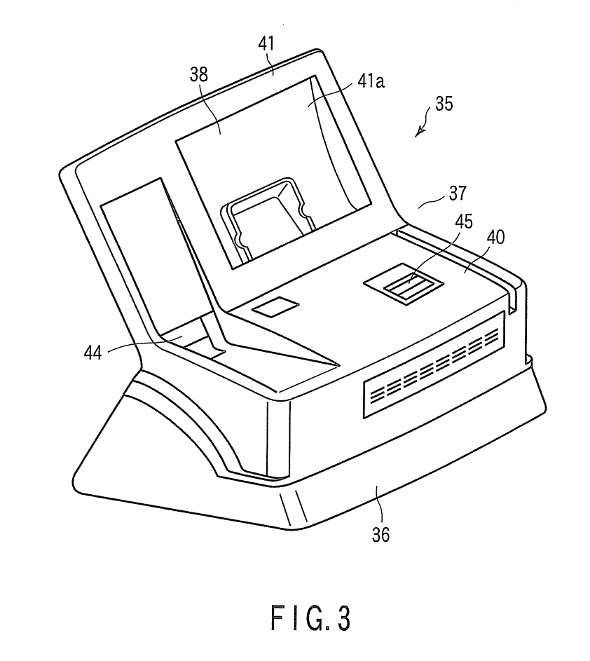

FIG. 3 shows a cover member 35 used in the case of using the above POS terminal apparatus 1 as a terminal apparatus 1 for self-checkout.

The cover member 35 includes a bottom cover 36, a main cover 37 which is removably attached to the top side of the bottom cover 36, and a rear cover 38 which is removably attached to the rear side of a stand-up cover section 41, later described, of the main cover 37.

The main cover 37 includes a horizontal cover section 40 and the stand-up cover section 41 which is formed integrally with the horizontal cover section 40 and stands up at a predetermined angle. In the stand-up cover section 41, an open window 41a and a receipt issuing port 44 are formed. In the horizontal cover section 40, a settlement terminal 45 for a card or the like is provided. The rear cover 38 is removably attached to the rear side of the stand-up cover section 41 of the main cover 37.

The main cover 37 has plural pawls on the bottom end side of the front side of the horizontal cover section 40. The main cover 37 is attached as these pawls are inserted inside at the upper end of the bottom cover 36 and both lateral sides on the rear end of the horizontal cover section 40 are screwed to the bottom cover 36.

The bottom cover 36 has protrusions (not shown) on the inner side of both side walls. The bottom cover 36 is attached as these protrusions are inserted in holes (not shown) opened in both side walls of the drawer unit 2.

Plural units (for example, five or so) of the POS terminal apparatus 1 configured as described above are arranged on the checkout counter so that the store can cope with many customers rushing for the checkout counter when the store is crowded. However, if there are a small number of salesclerks, it is not possible to place salesclerks at all the POS terminal apparatuses 1.

In such case, for example, approximately three out of the five POS terminal apparatuses 1 are enabled to be used as terminal apparatuses 1 for self-checkout.

Next, the case of changing the POS terminal 1 to a terminal apparatus 1 for self-checkout will be described.

In this case, first, the customer-side display device 7 is removed from the apparatus body 1a and the hand scanner 11 is removed as well. Then, the cover member 35 is disassembled into the bottom cover 36, the main cover 37 and the rear cover 38.

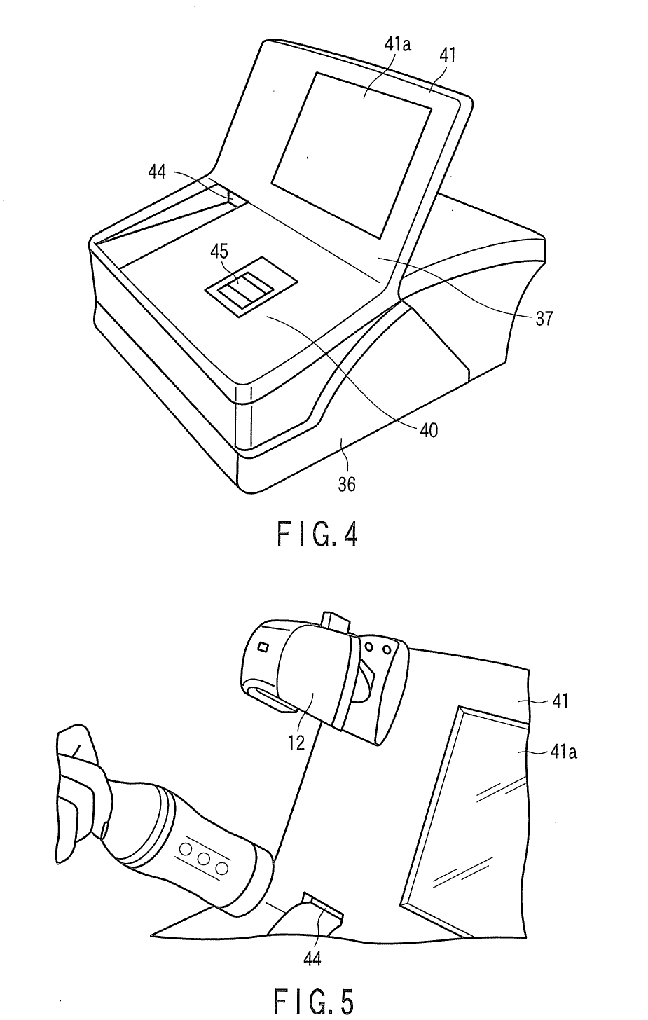

After the disassembly, the drawer unit 2 is covered with the bottom cover 36 as shown in FIG. 4 and the protrusions (not shown) on the inner side of both side walls of the bottom cover 36 are inserted in the holes (not shown) on both side walls of the drawer unit 2, thus attaching the bottom cover 36. Next, the operation unit including the keyboard 3 is covered with the horizontal cover section 40 of the main cover 37, and the clerk-side display device 6 is covered with the stand-up cover section 41. Then, the plural pawls (not shown) on the lower end side of the front side of the horizontal cover section 40 are inserted inside the upper end of the bottom cover 36, and both lateral sides on the rear end of the horizontal cover section 40 are screwed and fixed to the bottom cover 36.

Thus, both lateral sides and the front side of the drawer unit 2 are covered with the bottom cover 36. The operation unit including the keyboard 3 is covered with the horizontal cover section 40. The clerk-side display device 6 is covered with the stand-up cover section 41. The clerk-side display device 6 is exposed outside through the open window 41a in the stand-up cover section 41.

After the main cover 37 is attached, the rear cover 38 is attached to the rear side of the clerk-side display device 6, thus covering the clerk-side display device 6. Then, the fixed scanner 12 is attached to one end side of the front side of the stand-up cover section 41 of the main cover 37 as shown in FIG. 5.

After the cover member 35 is attached, the direction of the POS terminal apparatus 1 is changed toward the customer side so that the clerk-side display device 6 faces the customer, and the clerk-side display device 6 is thus enabled to be used as a customer-side display device. At this time, the customer cannot contact the operation unit including the keyboard 3 and the drawer unit 2 that are covered by the cover member 35, and the POS terminal apparatus 1 can be used as a terminal apparatus 1 for self-checkout. If the customer operates the keyboard 3 or the like, article transaction information cannot be accurately managed.

The customer holds the barcode of an article in hand over the fixed scanner 12 of the POS terminal apparatus 1 that is changed for self-checkout, and thus views and checks the amount of payment and so on displayed on the display device 6. After that, the customer holds a card over the settlement terminal 45 and thus ends the transaction.

As described above, according to this embodiment, simply by attaching the cover member 35 to the normal POS terminal apparatus 1, it becomes possible to use the apparatus as a terminal apparatus for self-checkout. Therefore, it is possible to cope with crowding without separately installing a dedicated terminal apparatus for self-checkout as in the conventional technique, and to realize reduction in workforce and reduction in cost.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A checkout terminal apparatus comprising:
an apparatus body;
an operation unit provided in the apparatus body and adapted for inputting transaction information of an article;
a control unit which executes article sale processing based on the transaction information inputted by the operation unit; and
a cover member which is removably attached to the apparatus body according to need and covers at least the operation unit.

2. The apparatus of claim 1, comprising:
a customer-side display device which is removably attached to the apparatus body and displays transaction information of an article to a customer;
a clerk-side display device which is provided in the apparatus body and displays transaction information of an article to a salesclerk; and
a drawer section provided on a lower side of the apparatus body.

3. The apparatus of claim 2, wherein at the time of attaching the cover member, the customer-side display device is removed and a fixed scanner which optically scans information of the article is attached to the cover member.

4. The apparatus of claim 2, wherein in a stage before being attached to the apparatus body, the cover member includes bottom cover, a main cover which is removably attached to an upper side of the bottom cover, and a rear cover which is removably attached to the main cover.

5. The apparatus of claim 4, wherein the bottom cover, the main cover and the rear cover are attached to the apparatus body after being disassembled, the bottom cover covers the drawer section, the main cover covers the operation unit, and the rear cover covers a rear side of the clerk-side display device.

6. The apparatus of claim 4, wherein the main cover includes a horizontal cover section and a stand-up cover section which is formed integrally with the horizontal cover section and stands up at a predetermined angle.

7. The apparatus of claim 6, wherein the horizontal cover section covers the operation unit, and the stand-up cover section covers the clerk-side display device.

8. The apparatus of claim 7, wherein the horizontal cover section has a settlement terminal.

9. The apparatus of claim 7, wherein the stand-up cover section has an open window through which the clerk-side display device is exposed.

10. The apparatus of claim 1, wherein the operation unit is a keyboard.
